(19) United States
(12) Patent Application Publication
(10) Pub. No.: US 2017/0253401 A1
(43) Pub. Date: Sep. 7, 2017

(54) SYSTEM AND METHOD FOR PACKAGING ITEMS FOR SHIPPING USING ADDITIVE MANUFACTURING

(71) Applicant: Design Net Technical Products, Inc., Smithfield, RI (US)

(72) Inventor: Robert J. Bouthillier, Smithfield, RI (US)

(21) Appl. No.: 15/448,702

(22) Filed: Mar. 3, 2017

Related U.S. Application Data
(60) Provisional application No. 62/303,778, filed on Mar. 4, 2016.

(51) Int. Cl. B65D 65/38; B65B 5/02; G05B 19/042; B33Y 80/00; B33Y 10/00; B33Y 50/02; B29C 67/00; B65D 61/00; G05B 17/02

(52) U.S. Cl. CPC B65D 65/38; B65D 61/00; B65B 5/02; G05B 19/0426; G05B 17/02; B33Y 10/00; B33Y 50/02; B29C 67/0088; B33Y 80/00; G05B 2219/49023; G06Q 10/083

(57) ABSTRACT

The method for packaging objects for shipping, which may be configured as a single all-in-one device, is carried out by scanning or selecting an item to be packaged from a catalogue and then using that information to generate a custom shipping enclosure using additive manufacturing techniques. Additive manufacturing techniques to create these custom shipping packages may include 3D printing, extrusion and sintering based processes as well as other techniques obvious to those skilled in the art. This method has an additional benefit of allowing greater quantities of items to fit on pallets, in shipping containers, and even in warehouses and on retail shelves.

### CROSS-REFERENCE TO RELATED APPLICATION

This patent document claims priority to earlier filed U.S. Provisional Patent Application Ser. No. 62/303,778, filed Mar. 4, 2016, the entire contents of which are incorporated herein by reference.

### BACKGROUND OF THE INVENTION

The present invention relates to a method of custom packaging items for shipping by scanning one or more items or selecting a catalogued item from a library and using additive manufacturing to create a custom shipping package for the scanned or selected item(s).

Currently, those who ship items in packages, such as stores, businesses and individuals, must obtain and store their packaging materials onsite or must acquire them prior to shipping. Storing packaging materials, especially for a variety of differently sized items, can take up quite a bit of space. Assembling the packaging materials prior to shipping also requires space, as well as assembly time. The packaging materials that are available are not ideally sized for most items that are shipped, and this is especially true for the most popular shipping package, the cardboard box. Cardboard boxes are rectangular in shape and available in a finite number of sizes; many items that are shipped are not rectangular and require a great deal of packing material to be placed in the box to fill the space to keep an irregular object in a secure position. Although there are some alternatives, corrugated cardboard is often heavy, making it costly to ship and many of the readily available packing materials utilize plastic, foam and other materials that are not “green” or environmentally friendly.

The present invention is a method for custom packaging that can be created on demand using a device that may be equipped with a built-in scanner to scan the item to be shipped, then save that item's profile for future use, as well as provide an option for the user to select packaging from a catalogue, either based on an identifier such as SKU or product id number or by its type or dimensions and then use additive manufacturing techniques to create a form-fitting, custom shipping package that will reduce excess packaging materials and make shipments that are lighter, smaller and more cost efficient to transport.

Therefore, there is a need for a system and method for packaging items that avoids the storage of space consuming packaging materials. There is a need for a system and method for packaging items that creates packaging material that is custom fit to the item to be packaged. There is another need for a method and system for packaging items that is environmentally friendly. There is a further need for a method and system for packaging items that can produce packaging on demand. Finally, there is a need for a method and system for packaging items that reduces excess packaging materials and make shipments lighter, smaller and more cost efficient to transport.

### SUMMARY OF THE INVENTION

This invention relates to a method for packaging objects for shipping, which may be configured as a single all-in-one device, by scanning or selecting an item to be packaged from a catalogue and then using that information to generate a custom shipping enclosure using additive manufacturing techniques. Additive manufacturing techniques to create these custom shipping packages may include 3D printing, extrusion and sintering based processes as well as other techniques obvious to those skilled in the art. This method has an additional benefit of allowing greater quantities of items to fit on pallets, in shipping containers, and even in warehouses and on retail shelves.

The method of the present invention removes the need for a business or individual to store a multitude of shipping containers and packing materials. It further improves on the current method of packaging items as this makes it easy to send shipping details, including size and weight to a shipping carrier, such as UPS, FedEx, USPS and the like directly from the device and to obtain the most cost efficient pricing for the shipment.

The additive manufacturing techniques used in this packaging method may utilize eco-friendly options such as renewable, recycled, biodegradable or other “green” materials to not only reduce shipping costs but to also create a more sustainable or option to presently available methods and materials.

Therefore, an object of the present invention is to provide system and method for packaging items that avoids the storage of space consuming packaging materials.

A further object of the present invention is to provide a system and method for packaging items that creates packaging material that is custom fit to the item to be packaged.

Another object of the present invention is to provide a method and system for packaging items that is environmentally friendly.

Yet another object of the present invention is to provide a method and system for packaging items that can produce packaging on demand.

A further object of the present invention is to provide a method and system for packaging items that reduces excess packaging materials and make shipments lighter, smaller and more cost efficient to transport.

### BRIEF DESCRIPTION OF THE DRAWING FIGURES

Other objects, features and advantages of the invention shall become apparent as the description thereof proceeds when considered in connection with the accompanying illustrative drawings, in which:

FIG. 1 is a block diagram illustrating the parts of the scanning and additive manufacturing system;

FIG. 2 illustrates an example of one half of a disassembled 4 piece rails-type structure;

FIG. 3 illustrates an example of one half of an assembled 4 piece rails-type structure;

FIG. 4 illustrates an example of one embodiment of a shipping structure that utilizes a combined structure for a more complex packaging solution; and

FIG. 5 is an example of extruded plastics.

### DESCRIPTION OF THE INVENTION

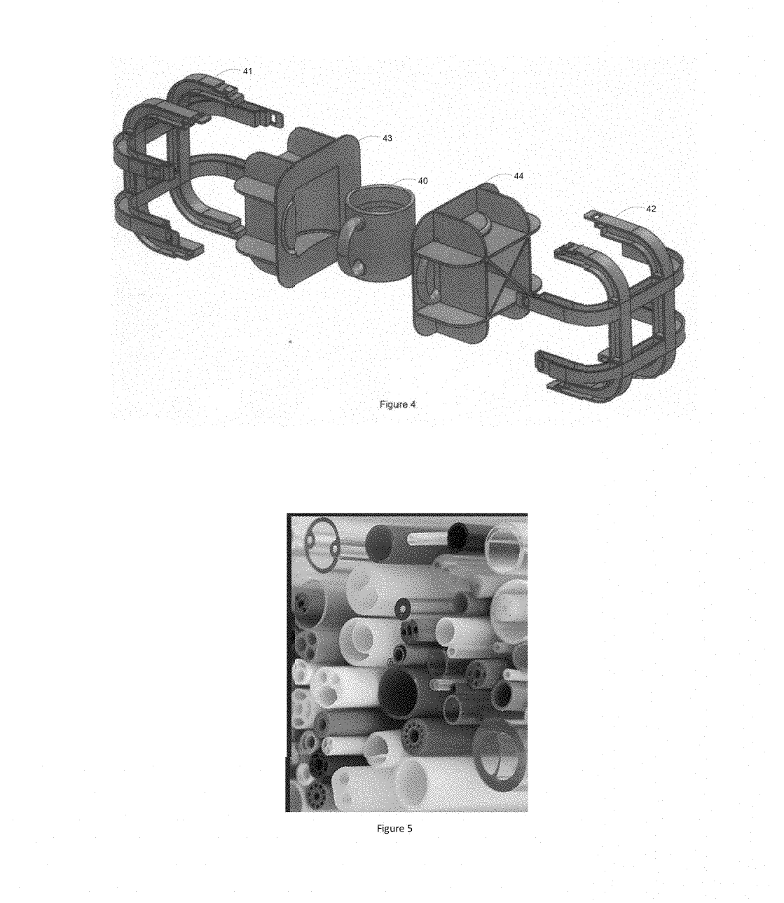

The present invention provides for options to create different types of packaging structures, including biodegradable structures. The desired type of structure may differ based on the fragility of the item being packed, the number of items being packed, where the item is being sent or to comply with shipping and package-handling standards. FIGS. 2 and 3 show these packaging structures may be comprised of a simple rail-like framework that is generated as one or more pieces 20, 21 and assembled 30, 31 around the item, they may be generated as top/bottom or multi-piece structures that fit around and item and in other instances, they may be more enclosure-like structures that fit together 30, 31 or simply fit around the item. The structures may be printed as enclosures, that require disassembly and reassembly using interlocks 32 to package an item or they may be printed as separate pieces, with or without interlocks. FIG. 4 shows an example of a packaging structure that utilizes a combined structure for a more complex shipping solution. The custom structures 43 and 44 fit around the item 40 and the rail-like structures 41 and 42 fit around the custom structures. These structures may be printed as enclosures or as separate pieces, with or without interlocks.

Another type of packaging structure may be formed by extruding an “x” shaped cross-section, which is processed through the nozzle without being heated, until a point in which the shape of the structure requires the material to be fused or bonded to another point in the structure. This material may come on a roll, as does filament. The bonding is done by using a “welding” technique that is achieved by heating the material at the tip of the nozzle and fusing it to another point on the structure. This method of extruding an unheated material and fusing it only at particular points allows for a much quicker process than what is used in traditional 3D printing methods.

These packaging structures form a matrix that fits around an item or secures it in place and can be wrapped, creating a lightweight, water resistant package.

Another embodiment of this invention is particularly useful for products produced using additive manufacturing. After a part or assembly is 3D printed, the packaging may be 3D printed on the same machine, or on a neighboring machine. The design of the packaging may be generated by the designer, or it may be auto-generated by software algorithms which take shipping container requirements into account to ensure that the package meets shipping requirements and that the “contents” of the package will be protected during shipment.

It should be understood that the design of the packaging may be carried out using known 3D printing equipment, which optionally uses known computer equipment that includes a microprocessor, memory, storage, I/O ports, power source and other components found in a computer device. The storage device may be a hard drive, solid state, optical drive or the like. The computer equipment may or may not be connected to a network, such as the Internet, to facilitate access and storage of the data therein. Such computer equipment may be used for carried out any of steps of the method of the present invention. The appropriate software may be employed to carry out the 3D printing operation in accordance with the present invention.

This approach reduces handling of 3D printed parts and assemblies and it can be implemented in a standalone kiosk format which enables the 3D printer/shipper kiosk to be located at a UPS shipper, at a post office, or even in an Airport or other facility.

A key benefit of a pack and ship kiosk is that it may be located at any retail location and would thus server as an automated packing platform which would generate a package for nearly any item.

The architecture of this system is superior to the current state of additive manufacturing because it not only permits the “filament” to build upon itself in directly adjacent layers, but this approach permits the “filament” to be fed from the nozzle without heating until the filament must be welded to another piece. This allows for substantially faster operation and thus faster completion of the packaging.

In the present invention, the filament may have a cross-sectional structure that permits it to stand on its own and to be able to bear weight across a span of space. In traditional 3D printing, all extruded material must be built upon an underlying structure because the extruded filament is dispensed at high temperature and applied in a molten state.

While the process of the present invention may heat the filament to a molten state, it may also simply feed the filament while cool, and thus may build structures that may be assembled using extruded lengths to build a cage between a top and a bottom panel. The unheated extruded lengths may also be fused into a series of geometric patterns to provide strength and protection to a side or top-panel. The ends of these extruded lengths may be heated to weld them to the rest of the structure, or they may be cut off to be used to assemble a shipping structure in a tinker-toy fashion.

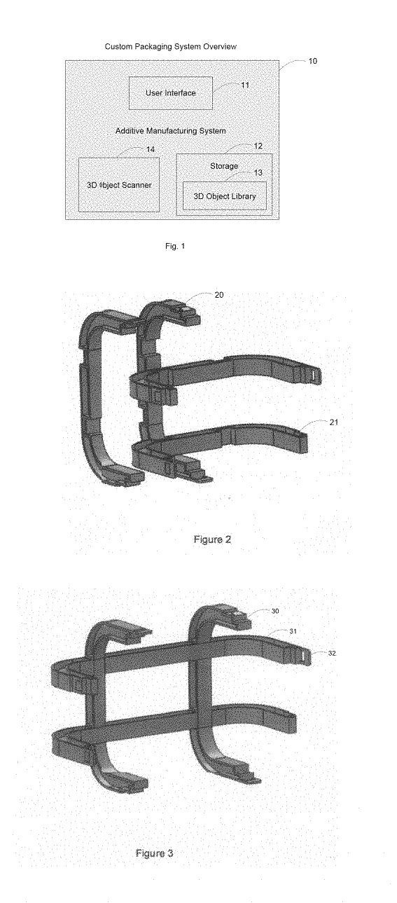

FIG. 1 provides an overview of one embodiment of the custom packaging system. The process to create a shipping package using the method of the present invention is to use the user interface 11 to identify the packaging required, which may include scanning 14 the product to be packaged, saving the object to storage 12 in the 3D object library 13, which may be located in a computer database, for example, and then generating the custom shipping structure that will surround the product using additive manufacturing techniques 10. The product, with the surrounding structure can then be placed in an enclosure or wrapped, likely in an opaque material and labeled for shipment. Suitable wraps for these enclosures may include bubble wrap or shrink wrap, bubble bags, shrink airbag, double walled stretch, or other similar options. Alternatively, the object may be selected from the 3D object library 13 and generated without scanning the object. Objects may be stored 12 in the 3D object library as previously scanned, favorites, or from SKU or brand lists. Users can select any number of duplicate packing structures to generate at a time, whether they scan 14 the object or select from the 3d object library 13. Multiple different structures can also be queued and generated in succession.

The scanner/catalogue provides options to confirm object location and orientation, using on screen images, lights and the like to guide the user and simplify the process.

The method for the present invention can be applied to various uses including, but not limited to creating shipping structures to surround a single item, creating shipping structures to surround multiples of the same item or creating shipping structures to surround a group of different items, all which can be packed in the custom generated package and then wrapped and shipped or placed in a packing container, such as a box or arranged on pallets for shipping in quantities. Alternatively, this method can be used to generate custom gussets to protect products, such as appliances, electronics, or other fragile items, as well as to create other means of packaging protection that are obvious to those skilled in the art.

One embodiment of the present invention is a kiosk for use by businesses, post offices or other shipping businesses.

It would be appreciated by those skilled in the art that various changes and modifications can be made to the illustrated embodiments without departing from the spirit of the present invention. All such modifications and changes are intended to be covered by the appended claims.

What is claimed is:

1. A method for custom packaging items using additive manufacturing, comprising:
providing a 3D object scanner;
providing a 3D printer;
scanning an object with a 3D object scanner;
creating a data file of the scanned object;
saving the data file; and
additively 3D custom printing packaging for the object using a 3D printer.
